(19) United States
(12) Patent Application Publication
(10) Pub. No.: US 2013/0029507 A1
(43) Pub. Date: Jan. 31, 2013

(54) PROTECTING PLUG FOR AUDIO JACK

(71) Applicant: CHING-YAO YANG, Taipei City (TW)

(72) Inventor: CHING-YAO YANG, Taipei City (TW)

(73) Assignee: HAW YANG CO.,LTD., Taipei City (TW)

(21) Appl. No.: 13/278,760

(22) Filed: Oct. 21, 2011

(30) Foreign Application Priority Data
Jul. 28, 2011 (TW) 100213929

(51) Int. Cl. H01R 13/44

(52) U.S. Cl. 439/148

(57) ABSTRACT

A protecting plug for an audio jack includes a plug member and a decoration member. The plug member has a plug portion matching with an audio jack, a coupling portion, and a flange portion provided between the coupling portion and the plug portion. The decoration member includes a model portion, a coupling hole formed on the model portion, and a decoration connecting portion formed at a boundary surface of the coupling hole. By coupling the coupling portion to the coupling hole and making a receiving surface of the flange portion hold and/or connect with the decoration connecting portion, the plug member is assembled with the decoration member.

### FIELD OF THE INVENTION

The present invention relates to a member used for protecting an audio jack, and more particularly to a protecting plug for an audio jack.

### BACKGROUND OF THE INVENTION

With the progress of technology, the electron products are widely used. The electron products such as mobile phones, music players, computers, portable game machines, and the like are mostly equipped with an audio jack for connecting with an audio output device such as an earphone, a speaker, and the like, so as to answer the phone, play the music and sounds.

For connecting with the audio output device, the audio jack is usually formed on an outer surface of the electron product, but it also causes the possibility of contamination from dust, moisture, or rainwater. Once the audio jack is stained or damped, it may not only cause a bad electrical connection which makes an audio signal, transmitted by the audio jack, contain noise, but also it causes an inner circuit being damage to bring a breakdown of the audio jack in the worst case. For some electron products, the breakdown of the audio jack leads to the whole out of function of the electron product.

In order to avoid the above problems, a conventional protecting plug is introduced to insert into the audio jack when it is not in use so as to prevent the dust or water from intrusion.

### SUMMARY OF THE INVENTION

However, although a tight connection between the protecting plug and the audio jack can prevent the audio jack from intrusion of dust and water, it also results in hard removal of the protecting plug from the audio jack. Moreover, some designs with a larger protecting plug provided thereon for easily being removed may affect the aesthetic feeling of the whole design, and thus the volume of the product becomes unexpected larger.

Therefore, it is an object of the present invention to provide a protecting plug for an audio jack which overcomes the above drawbacks.

The present invention overcomes the drawbacks of the prior arts, and provides a protecting plug for an audio jack, comprising: a plug member having a coupling portion, a flange portion, and a plug portion matching with the audio jack, the flange portion being provided between the coupling portion and the plug portion with a thickness in a receiving direction and having a first extension surface facing the plug portion and a second extension surface facing the coupling portion, and the coupling portion being formed extending form the second extension surface; and a decoration member, including a model portion, a coupling hole formed on the model portion, and a decoration connecting portion formed at a boundary surface of the coupling hole, whereby coupling the coupling portion of the plug member to the coupling hole and making the second extension surface served as a receiving surface to hold and/or connect with the decoration connecting portion, the plug member is assembled with the decoration member.

In an embodiment of the present invention, the plug portion has a configuration substantially equivalent to an earphone plug.

In an embodiment of the present invention, the decoration member further includes a hoisting ring portion connected with the model portion.

In an embodiment of the present invention, the coupling portion is a cylindrical body having a diameter less than that of the plug portion.

In an embodiment of the present invention, the coupling portion is further provided with an elastic abutment part.

In an embodiment of the pre-sent invention, an adhesive layer is formed between the coupling portion and the coupling hole.

In an embodiment of the pre-sent invention, an adhesive layer is formed between the receiving surface and the decoration connecting portion.

In an embodiment of the present invention, a joint portion is connected between the plug portion and the flange portion.

In an embodiment of the present invention, the joint portion is made of a flexible material.

In an embodiment of the present invention, the flange portion and the plug portion are independent portions, wherein the flange portion has a fastening part extending toward the plug portion, the plug portion has a fastening slot corresponding to the fastening part, and the fastening part is fastened to the fastening slot.

Thereby, an outside portion where the protecting plug exposed to outside of the audio jack of the electron product is the decoration member, which can be used to be grabbed by a user in such a manner to remove the protecting plug from the audio jack, and can be treated merely as a decoration that does not affect the integral structure and the visual aesthetics of mobile phones. Further, because the plug member and the decoration member are independent members, it makes the plug member can be mass produced to reduce costs, and on contrary makes the decoration member possible be allowed to be refined as a manual product.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a perspective view illustrating a first embodiment according to the present invention;

FIG. 2 is an explosion diagram of FIG. 1;

FIG. 3 is an explosion diagram illustrating a second embodiment according to the present invention;

FIG. 4 is an explosion diagram illustrating a third embodiment according to the present invention;

FIG. 5 is an explosion diagram illustrating a fourth embodiment according to the present invention;

FIG. 6 is an explosion diagram illustrating a fifth embodiment according to the present invention; and

FIG. 7 is an explosion diagram illustrating a plug member of an embodiment according to the present invention.

### DETAILED DESCRIPTION OF THE PREFERRED EMBODIMENTS

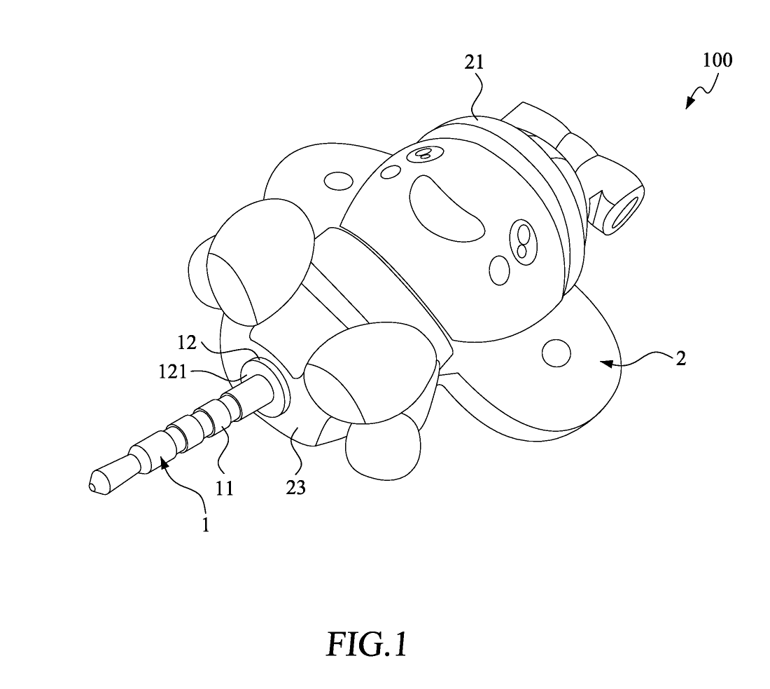

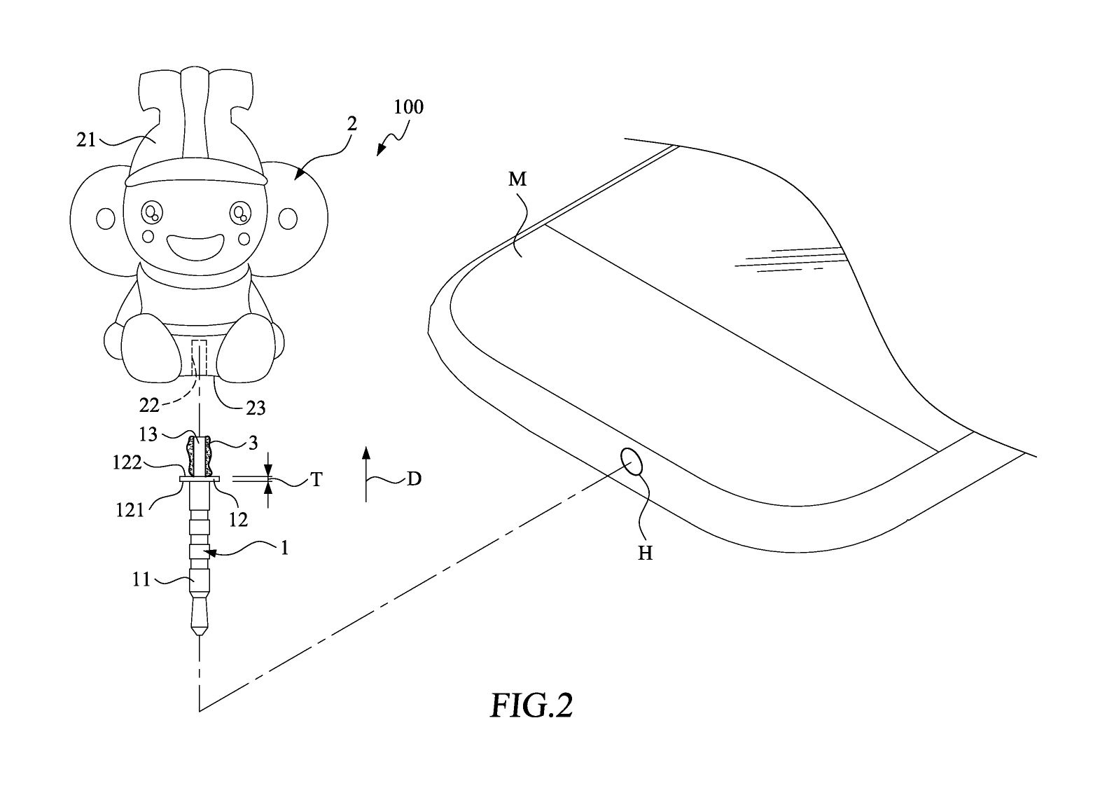

Please refer to FIGS. 1 and 2. FIG. 1 is a perspective view illustrating a first embodiment according to the present invention, and FIG. 2 is an explosion diagram of FIG. 1. As shown in FIGS. 1 and 2, a protecting plug 100 for an audio jack according to a first embodiment of the present invention includes a plug member 1 and a decoration member 2.

The plug member 1 has a plug portion 11, a flange portion 12, and a coupling portion 13. The plug portion 11, which matches with an audio jack H, can have a variety of configurations. For example, the plug member 11 in this embodiment has a configuration substantially equivalent to an earphone plug. Therefore, the plug member 11 of the plug member 1 can plug into, for example, the audio jack H of a mobile phone M so as to prevent dust and moisture from intruding the audio jack H. The flange portion 12 is provided between the plug portion 11 and the coupling portion 13 with a thickness in a receiving direction D. And, the flange portion 12 has a first extension surface 121 facing the plug portion 11 and a second extension surface 122 facing the coupling portion 13. The coupling portion 13 is formed extending form the second extension surface 122.

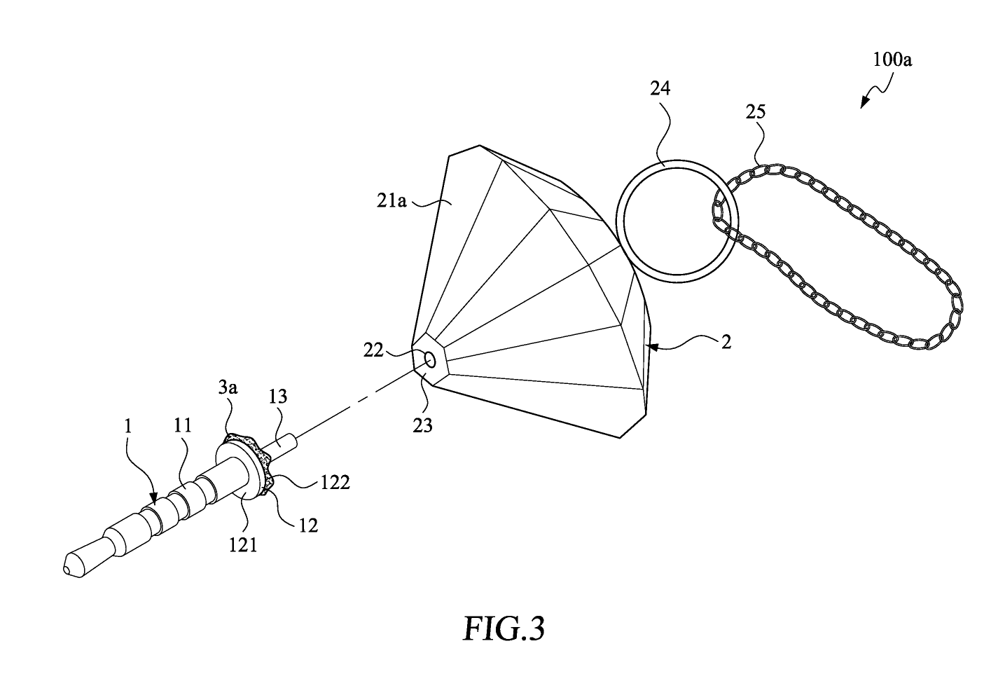

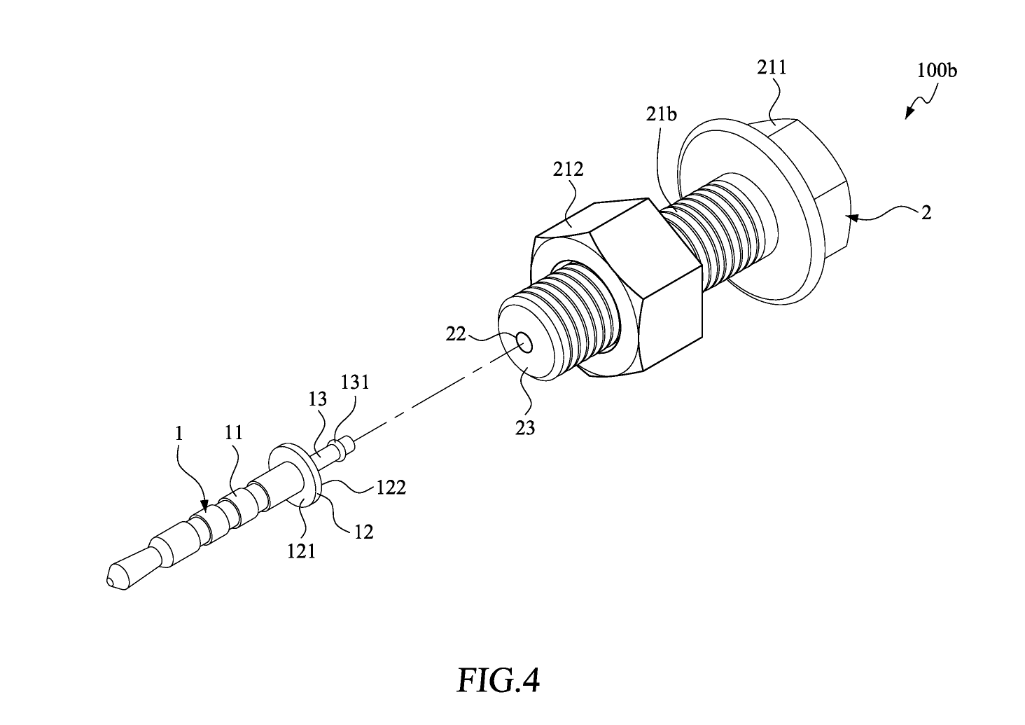

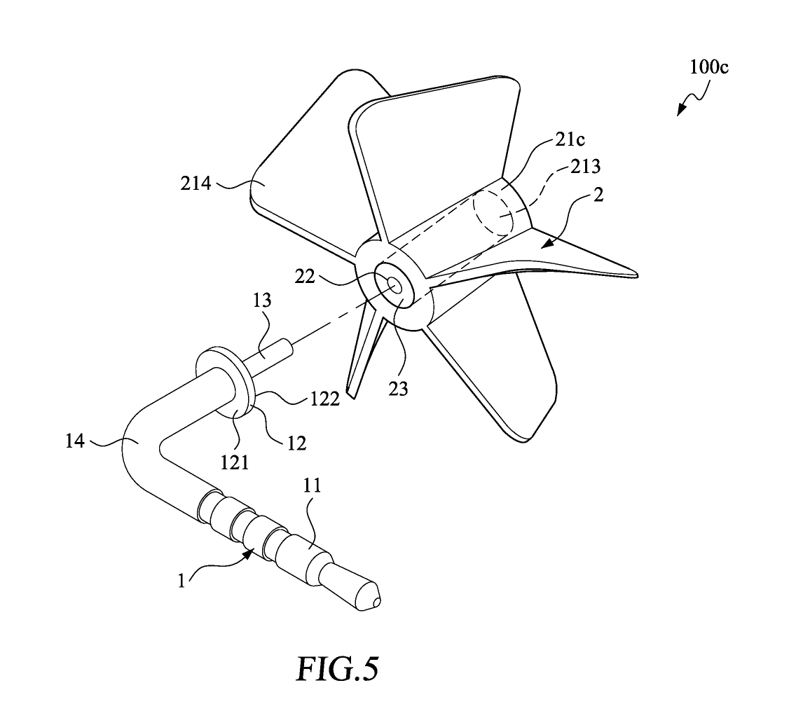

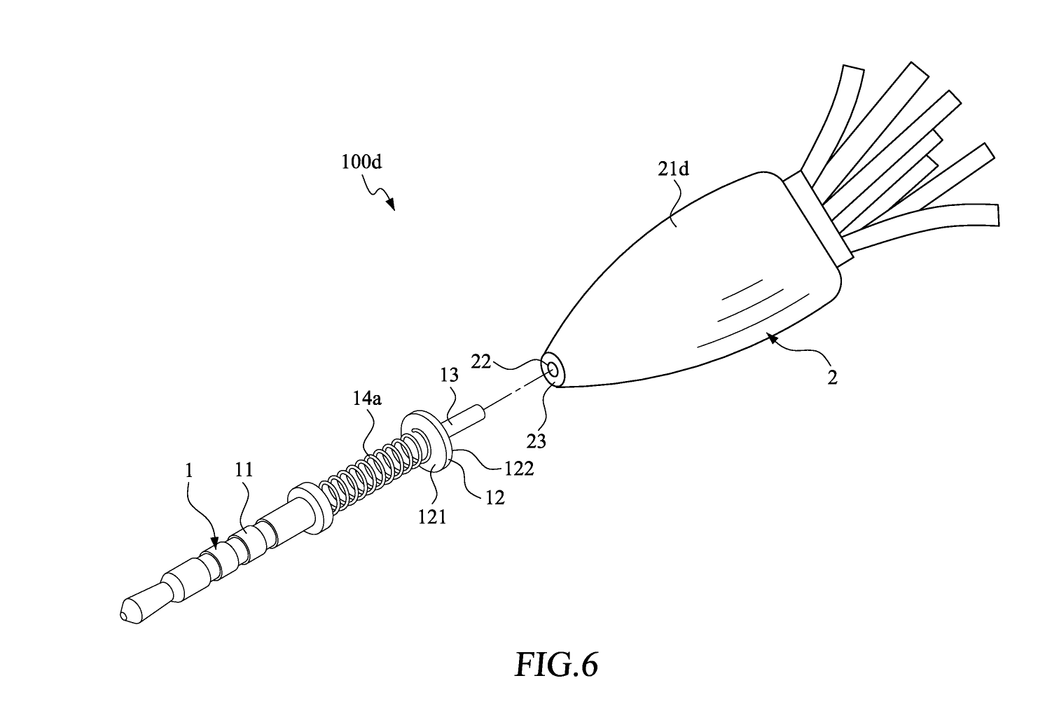

The decoration member 2 includes a model portion 21, a coupling hole 22, and a decoration connecting portion 23. The model portion 21 can be any configurations such as a figure configuration (as shown in FIGS. 1 and 2), a jewel configuration (as shown in FIG. 3), a mechanical part configuration (as shown in FIG. 4), an actuating mechanism configuration (as shown in FIG. 5), a vegetable-like or fruit-like configuration (as shown in FIG. 6), and the like. The coupling hole 22, which formed on the model portion 21, has a hole diameter corresponding to the coupling portion 13 to couple with the coupling portion 13. The decoration connecting portion 23, which is formed at a boundary surface of the coupling hole 22, may have a flat surface or a curved surface.

With above structures, by serving the second extension surface 122 of the flange portion 12 of the plug member 1 as a receiving surface, then coupling the coupling portion 13 of the plug member 1 to the coupling hole 22 of the decoration member 2 in the receiving direction D, and then making the receiving surface (the second extension surface 122) to hold and/or connect with the decoration connecting portion 23 of the decoration member, the plug member 1 is thus assembled with the decoration member 2.

Thereby, when the protecting plug 100 is plugged in to the audio jack H of the mobile phone M, the decoration member 2 can be used to be grabbed by a user in such a manner to remove the protecting plug 100 from the audio jack H, and can be treated merely as a decoration that does not affect the integral structure and the visual aesthetics of the mobile phone M. Further, because the plug member 1 and the decoration member 2 are independent members, it makes the plug member 1 can be mass produced to reduce costs, and on the contrary makes the decoration member 2 be allowed to be refined as a manual product.

In this embodiment, the coupling portion 13 of the plug member 1 is a cylindrical body. And, a diameter of the cylindrical body (coupling portion 13) is less than that of the plug portion 11. That is, width of the plug portion 11 is large than that of the coupling portion 13, so that the decoration member 2 received by the flange portion 12 can be supported by the plug portion 11 to prevent from a tilt to it.

In addition, in order to make a stronger connection between the plug member 1 and the decoration member 2, an adhesive layer 3 may be provided between the coupling portion 13 and the coupling hole 22. Alternatively, an adhesive layer 3a may be provided between the receiving surface (the second extension surface 122) and the decoration connecting portion 23 (as shown in FIG. 3). Of course it is also possible to provide both of the adhesive layer 3 and 3a at two places respectively.

Please refer to FIG. 3, which is an explosion diagram illustrating a second embodiment according to the present invention. The elements of the protecting plug 100a for audio jack in this embodiment is similar to those in the first embodiment. The same elements in this embodiment are labeled with the same reference number as in the first embodiment.

The difference between the second embodiment and the first embodiment is that a model portion 21a of the decoration member 2 is a jewel configuration (i.e., a diamond configuration). And, the decoration member 2 further includes a hoisting ring portion 24 connected with the model portion 21a. The hoisting ring portion 24 can be tied by a chain 25 for the purpose of convenient carrying or for being used as a key ring for holding keys and the like. In addition, the adhesive layer 3a is provided between the second extension surface 122 and the decoration connecting portion 23 to make a stronger connection therebetween.

Please refer to FIG. 4, which is an explosion diagram illustrating a third embodiment according to the present invention. The elements of the protecting plug 100b for audio jack in this embodiment is similar to those in the first embodiment. The same elements in this embodiment are labeled with the same reference number as in the first embodiment.

The difference between the third embodiment and the first embodiment is that a model portion 21b of the decoration member 2 is a mechanical part configuration (i.e., a screw assembly). Further, the model portion 21b can consist of two or more parts. For example, the model portion 21b in this embodiment includes a main model part 211 (i.e., a screw) and a sub-model part 212 (i.e., a nut) screwed on the main model part 211, so as to provide an additional function as well as decorative function. Moreover, the coupling portion 13 is further provided with an elastic abutment part 131 which applies an abutment force to an inner wall of coupling hole 22 to prevent the coupling portion from coming off the coupling hole 22 after coupling portion 13 is coupled to the coupling hole 22.

Please refer to FIG. 5, which is an explosion diagram illustrating a fourth embodiment according to the present invention. The elements of the protecting plug 100c for audio jack in this embodiment is similar to those in the first embodiment. The same elements in this embodiment are labeled with the same reference number as in the first embodiment.

The difference between the fourth embodiment and the first embodiment is that a model portion 21c of the decoration member 2 is an actuating mechanism configuration (i.e., a propeller) including a bearing part 213 and a blade part 214 rotary connected with the bearing part 213. Thus it can be seen that the model portion is not limited to a static configuration, a dynamic configuration of the model portion also can be given. In addition, in order to prevent an electron product, in which the audio jack H is plugged with the protecting plug 100C, with a volume or size too big, which causes the product unable to lay horizontally on a flat surface, the plug member 1 in this embodiment is further provided with a joint portion 14 connected between the plug portion 11 and the flange portion 12. The joint portion 14 may have a bent configuration for changing the arranging direction of the decoration member 2 corresponding to the plug portion 11 of the plug member 1.

Please refer to FIG. 6, which is an explosion diagram illustrating a fifth embodiment according to the present invention. The elements of the protecting plug 100d for audio jack in this embodiment is similar to those in the first embodiment. The same elements in this embodiment are labeled with the same reference number as in the first embodiment.

The difference between the fifth embodiment and the first embodiment is that a model portion 21d of the decoration member 2 is a vegetable-like or fruit-like configuration (i.e., a Chinese radish). In Addition, the joint portion 14 of the plug member 1 is made of a flexible material and is a spring in this embodiment. Thus, the decoration member 2 assembled with the plug member 1 can change its arranging direction as appropriate, so as to place or to put into a pocket or a bag.

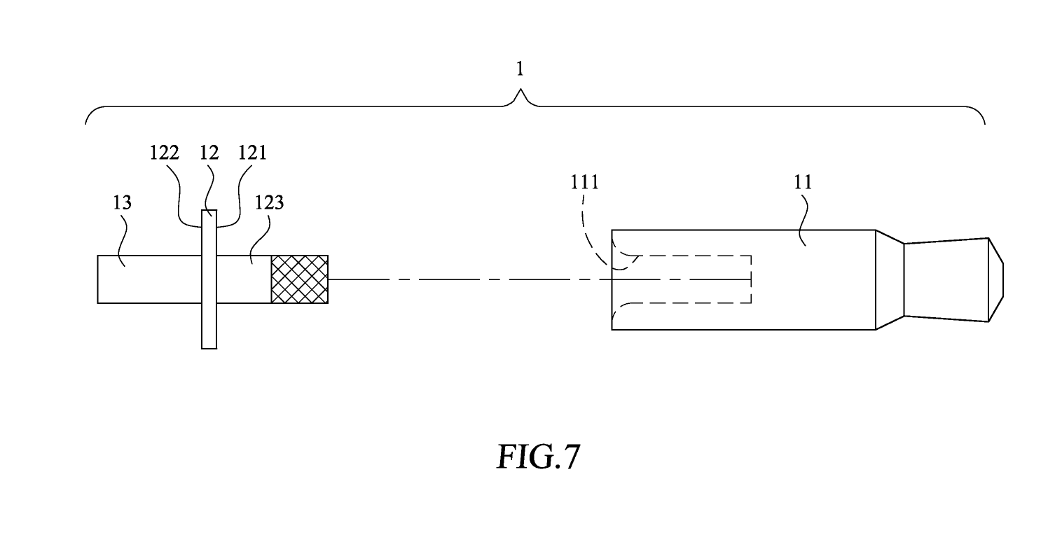

Please refer to FIG. 7, which is an explosion diagram illustrating a plug member of an embodiment according to the present invention. Besides being integrated formed as shown in FIG. 1, the plug portion 11 and the flange portion 12 of the plug member 1 can be independent portions. As shown in FIG. 7, the flange portion 12 has a fastening part 123 (e.g., a fastening pin) extending toward the plug portion 11. The plug portion 11 has a fastening slot 111 corresponding to the fastening part 123. The fastening part 123 is fastened to the fastening slot 111 so that the plug portion 11 is assembled with the flange portion 12. A chequered configuration or left handed threads may be provided on the fastening part 123 (in this embodiment, the chequered configuration is provided) so as to enhance the assembling force to the fastening slot 111. In such a way, the plug portion 11 and the flange portion 12 may be made of different materials. For example, the flange portion 12 may be made of a metal material, such as iron, which has a high strength for supporting the decoration member 2; and the plug portion 11 may be made of a plastic material, such as ABS (Acrylonitrile Butadiene Styrene), which is suitable for sealing up the audio jack. However, the plug portion 11 may be made of a metal material.

As can be appreciated from the above embodiments, the protecting plug of the present invention has industry worth which meets the requirement for a patent. The above description should be considered as only the discussion of the preferred embodiments of the present invention. However, a person having ordinary skill in the art may make various modifications to the present invention Those modifications still fall within the spirit and scope defined by the appended claims.

What is claimed is:

1. A protecting plug for an audio jack, comprising:
a plug member having a coupling portion, a flange portion, and a plug portion matching with the audio jack, the flange portion being provided between the coupling portion and the plug portion with a thickness in a receiving direction and having a first extension surface facing the plug portion and a second extension surface facing the coupling portion, and the coupling portion being formed extending form the second extension surface; and
a decoration member, including a model portion, a coupling hole formed on the model portion, and a decoration connecting portion formed at a boundary surface of the coupling hole,
whereby coupling the coupling portion of the plug member to the coupling hole and making the second extension surface served as a receiving surface to hold and/or connect with the decoration connecting portion, the plug member is assembled with the decoration member.

2. The protecting plug for an audio jack as claimed in claim 1, wherein the plug portion has a configuration substantially equivalent to an earphone plug.

3. The protecting plug for an audio jack as claimed in claim 1, wherein the decoration member further includes a hoisting ring portion connected with the model portion.

4. The protecting plug for an audio jack as claimed in claim 1, wherein the coupling portion is a cylindrical body having a diameter less than that of the plug portion.

5. The protecting plug for an audio jack as claimed in claim 1, wherein the coupling portion is further provided with an elastic abutment part.

6. The protecting plug for an audio jack as claimed in claim 1, wherein an adhesive layer is formed between the coupling portion and the coupling hole.

7. The protecting plug for an audio jack as claimed in claim 1, wherein an adhesive layer is formed between the receiving surface and the decoration connecting portion.

8. The protecting plug for an audio jack as claimed in claim 1, wherein a joint portion is connected between the plug portion and the flange portion.

9. The protecting plug for an audio jack as claimed in claim 1, wherein the joint portion is made of a flexible material.

10. The protecting plug for an audio jack as claimed in claim 1, wherein the flange portion and the plug portion are independent portions, wherein the flange portion has a fastening part extending toward the plug portion, the plug portion has a fastening slot corresponding to the fastening part, and the fastening part is fastened to the fastening slot.
